(19) United States
(12) Patent Application Publication
(10) Pub. No.: US 2022/0095525 A1
(43) Pub. Date: Mar. 31, 2022

(54) AUTONOMOUS OPERATION OF A VEHICLE WITHIN A SAFE WORKING REGION

(71) Applicant: ZF Friedrichshafen AG, Friedrichshafen (DE)

(72) Inventor: Michael Amann, Tettnang (DE)

(21) Appl. No.: 17/427,141

(22) PCT Filed: Jan. 31, 2020
(86) PCT No.: PCT/EP2020/052441

§ 371 Date: Jul. 30, 2021

(30) Foreign Application Priority Data
Feb. 1, 2019 (DE) 10 2019 201 297.3

(51) Int. Cl. A01B 69/04; G05D 1/02; G05D 1/00; G06T 7/579; G06T 7/73

(52) U.S. Cl. CPC A01B 69/008; G05D 1/0214; G05D 1/0223; G05D 1/0238; G05D 2201/0201; G05D 1/005; G06T 7/579; G06T 7/73; G05D 1/0278

(57) ABSTRACT

An apparatus for autonomously operating a vehicle within a safe work area includes a processor unit comprising an interface. The processor unit is configured to access a position of a vehicle determined by a module for position determination through a global localization via the interface, access an environmental detection of the vehicle generated by a sensor unit via of the interface, and control the vehicle based on the position of the vehicle determined by the module and further based on the environmental detection of the vehicle generated by the sensor unit.

### CROSS REFERENCE TO RELATED APPLICATIONS

This application is a U.S. National Phase application under 35 U.S.C. § 371 of International Application No. PCT/EP2020/052441, filed on Jan. 31, 2020, and claims benefit to German Patent Application No. DE 10 2019 201 297.3, filed on Feb. 1, 2019. The International Application was published in German on Aug. 6, 2020 as WO 2020/157282 A2 under PCT Article 21(2).

### FIELD

The disclosure relates to a processor unit, a system, a method and a computer program product for the autonomous operation of a vehicle within a safe work area.

### BACKGROUND

Relevant standards (e.g. ISO 18497) require collision avoidance for autonomously driven machines, in particular for agricultural use, a collision avoidance which is to be provided on the machine and is to transfer the machine to the safe state, mostly to standstill, in the event of an imminent collision. However, this measure does not prevent undesired leaving of an autonomous working area within which the machine operates and drives autonomously. This could result in collisions with other road users who could drive into the unexpectedly emerging machine.

Under current legal boundary conditions, the operation of an autonomously driving work machine is only allowed in closed areas, wherein the constructional manner of the shut-off is not clarified and it is thus not ensured that the shut-off would stop the machine upon an undesired leaving of the working area. Methods for defining a virtual zone (“Geo-Fencing”) are known. A global navigation satellite system (in English: Global Navigation Satellite System; short: GNSS) is used. GNSS is a System for determining the position and navigation on earth and in air by receiving the signals, in particular from navigation satellites. GNSS is combined with a map (DTM) in order to establish a safe work area (in English: Autonomous Operating Zone, abbreviated: AOZ) within which the machine is allowed to operate and drive autonomously.

GNSS has, among other things, the problems of accuracy (without additional measures), availability (shading) and ease of attack (Spoofing).

### SUMMARY

In an embodiment, the present disclosure provides an apparatus for autonomously operating a vehicle within a safe work area. The apparatus includes a processor unit comprising an interface. The processor unit is configured to access a position of a vehicle determined by a module for position determination through a global localization via the interface, access an environmental detection of the vehicle generated by a sensor unit via of the interface, and control the vehicle based on the position of the vehicle determined by the module and further based on the environmental detection of the vehicle generated by the sensor unit.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 a plan view of a working area within which a vehicle is allowed to travel autonomously;

FIG. 2 a plan view of a route on which the vehicle according to FIG. 1 may travel;

FIG. 3 an overlaid plan view of the working area according to FIG. 1 and the travel path according to FIG. 2;

FIG. 4 a plan view of an alternative working path, on which the vehicle may travel according to FIG. 1;

FIG. 5 an overlaid plan view of the working area according to FIG. 1 and of the working path according to FIG. 4 and

FIG. 6 a flow chart of a method for controlling the vehicle according to FIG. 1.

### DETAILED DESCRIPTION

The present disclosure provides for robust and safe monitoring of an autonomous working area.

According to the present disclosure, an approach is proposed, according to which global localization and local localization of a vehicle or a machine are combined with one another. This combined localization makes it possible to monitor, both at a global and at a local level, that the vehicle is within a safe autonomous working area and, if this is no longer the case or within a foreseeable period of time, suitable warning or countermeasures can be initiated.

In this sense, according to a first aspect, a processor unit is provided for autonomously operating a vehicle within a safe working area. The processor unit comprises an interface via which the processor unit can access a position of a vehicle determined by a module for position determination through a global localization and an environment detection of the vehicle generated by a sensor unit. The interface is a communication interface that enables the exchange of data, namely an exchange of data between the processor unit on the one hand and the module for determining the Position of the vehicle and the sensor unit on the other hand. The processor unit is furthermore configured to control the vehicle based on the position of the vehicle determined by the global localization and based on the environment detection of the vehicle generated by the sensor unit.

According to a second aspect, a system for autonomously operating a vehicle within a safe working area is analogously proposed. The System comprises a module for determining the position of a vehicle, a sensor unit for detecting an environment of the vehicle, and a processor unit. The position determination module is configured to determine a position of a vehicle by means of a global localization, and the sensor unit is configured to generate environment detection of the vehicle. Furthermore, the processor unit is configured to control the vehicle based on the position of the vehicle determined by the global localization and based on the environment detection of the vehicle generated by the sensor unit.

According to a third aspect, a corresponding method is proposed for the autonomous operation of a vehicle, e.g., an off-road vehicle, within a safe work area. The method may comprise the following steps: determining a position of a vehicle by means of a global localization by a module for position determination, generating an environment detection of the vehicle by means of a sensor unit, controlling the vehicle by means of a processor unit based on the Position of the vehicle determined by the global localization and based on the environment detection of the vehicle generated by the sensor unit.

According to a fourth aspect, a computer program product is furthermore proposed analogously, wherein the computer program product, if executed on a processor unit, directs the processor unit, access a position of a vehicle determined by a module for position determination through global localization by means of an interface, access at least one environmental detection of the vehicle generated by a sensor unit by means of the interface, and control the vehicle based on the position of the vehicle determined by the global localization and based on the environmental detection of the vehicle generated by the sensor unit.

According to a fifth aspect, a vehicle is provided, in particular an off-road vehicle. The vehicle may comprise a processor unit according to the first aspect. Alternatively or additionally, the vehicle may comprise a System according to the second aspect.

The following embodiments apply equally to the processor unit according to the first aspect, to the system according to the second aspect, to the method according to the third aspect, to the computer program product according to the fourth aspect and to the vehicle according to the fifth aspect.

The vehicle can be controlled by means of the processor unit. “Controlled” or “control” can be understood to mean that the vehicle can be operated autonomously, i.e., it can be automatically steered, accelerated and decelerated, for example, including all necessary controls in particular of the drivetrain, the steering and signaling of the vehicle.

The vehicle can be an off-road vehicle. An off-road vehicle can be understood to be a vehicle whose primary field of application is not a road (as is the case, for example, with passenger cars, buses or trucks), But, for example, farmland, for example, a field to be ordered or forest area, or a mining area (e.g., open cast mining), or an industrial surface, for example, within a production site or a storage hall. For example, the off-road vehicle can be an agricultural commercial vehicle, such as a combine harvester or tractor. Furthermore, the vehicle may be an industrial truck, for example a forklift or a tractor.

The processor unit can be integrated into a driver assistance system of the vehicle or communicatively connected to the driver assistance system. The processor unit can be configured to initiate that the vehicle is transferred to a safe state if the position determined by the position determination module for determining the position is not within the working area predefined as safe. In this context, “initiate” can be understood to mean that the processor unit transmits a command to a driver assistance system of the vehicle so that the driver assistance system transfers the vehicle into the safe state. For example, the driver assistance system can bring the vehicle to a standstill when it is transferred into the safe state.

The sensor unit is configured to detect a local environment of the vehicle. The resulting images or frames result in the environment detection. The environmental detection can thus, for example, be images if a camera or a camera system is used as a sensor. Furthermore, the environment detection can be frames if, for example, a radar or a lidar is used. The receptacles, e.g., the images or frames, each cover a limited area around the vehicle. This is meant by the feature “local”. The local environment of the vehicle is thus a limited region which extends outside around the vehicle. The local surroundings of the vehicle are preferably located within the working area. In other words, the local environment can be a subregion of the working area.

The range or extent of the local surroundings can deviate and, if necessary, be set depending on the sensor type used. The sensor system disclosed in the context of the present application is configured to be arranged, e.g., fastened, on the vehicle in such a way that it can detect the local environment of the vehicle. The area of the environment which the relevant Sensor detects may also be referred to as the so-called “Field of View”. Depending on the Sensor used, this region can be one-dimensional, two-dimensional or three-dimensional. It is possible for the region detectable by the Sensor to be able to detect a part of the surroundings of the vehicle, for example a sector in the preliminary region, in the lateral region or in the trailing region of the vehicle. Furthermore, the relevant Sensor can also be configured to detect the complete surroundings of the vehicle, for example when using so-called Surround View systems.

The local environment of the vehicle can be subdivided. For example, a specific Sensor of the sensor unit can detect a specific region around the vehicle. This detection area of the sensor can, for example, be divided into an inner region (“safe local working area”) located closer to the vehicle and an outer region located further from the vehicle. Depending on which range a potential collision object has been detected by the sensor unit and extracted by the processor unit from the appropriate environment detection, suitable countermeasures can be initiated in order to avoid a collision with the detected potential collision object. For example, if a tree has been detected and extracted within the outer region, the processor unit may, for example, cause the speed of the vehicle to be reduced only slightly, since the tree is still located relatively far away from the vehicle. However, if the tree has been detected and extracted within the inner area, the processor unit may, for example, cause the speed of the vehicle to be reduced very strongly or the vehicle to be stopped because the tree is in this case relatively close to the vehicle.

A “safe working area” can be understood to mean an operating area within which the vehicle can operate autonomously, wherein a collision of the vehicle with an object, in particular with another vehicle, an object, or with a human or animal, can be precluded with high probability. In other words, no object which could collide with the vehicle is highly likely to be located within the working area defined as safe. The working area can be a static area, i.e., this area is locally invariable. For example, the region may cover a field or part of a field. The field or the part of the field can be determined to be worked agriculturally by the vehicle. For example, the vehicle may have means which enable it to perform a specific operation within the working area, e.g., to plowing or harvesting grain in the field.

The local environment of the vehicle detected by the sensor unit is located within the working area. The local environment can thus be a subregion of the working area. The local environment may depend on a position of the vehicle. Depending on which position the vehicle is currently located, the local environment or field of view changes, and the sensor unit will detect other features and/or detect features already previously detected at different relative positions to the vehicle.

The processor unit is configured to evaluate the environment detection. The environment detection can, for example, be a recording of the local surroundings of the vehicle. For example, the processor unit is configured to extract objects from recordings or frames that have been generated by the sensor unit. For example, the processor unit can evaluate an image of a camera of the sensor unit and thereby determine whether the image images, i.e. contains or represents, a potential collision object.

For example, if the vehicle is on a first vehicle position at a first point in time, the sensor unit may, for example, detect a tree on a first tree position relative to the first vehicle position. If the vehicle now moves further, it is located at a second point in time on a second vehicle position that deviates from the first vehicle position, and a different environment of the vehicle is detected from the second vehicle position than from the first vehicle position. From this second vehicle position, the vehicle is detecting the previously detected tree either no longer or in a second tree position relative to the second vehicle position, wherein the second tree position deviates from the first tree position. Furthermore, the vehicle can, for example, detect another feature from the second Position, for example a hedge, which it could not yet capture it out of the first Position, for example because the hedge was not previously in the field of view of the vehicle.

In one embodiment, the processor unit is configured to check, in a first check step, whether the position determined by the module for position determination is within a working area, wherein the working area is predefined as a safe autonomous working area of the vehicle. Furthermore, the processor unit in this embodiment is configured, in a second test step, to check whether the environment detection maps at least one potential collision object and to control the vehicle based on the results of the two test steps.

The control of the vehicle based on the two inspection steps may include that it that the transfer of the vehicle into a safe state is initiated if it is determined in the first inspection step that the position determined by the module for position determination is outside of the working area. The transfer into the safe state can alternatively or additionally also be initiated when it is determined in the second test step that the environmental detection images at least one potential collision object. A potential collision object can be an object (stationary or movable, e.g., a tree or another vehicle), a human or an animal located within the detected local surroundings of the vehicle.

According to the present disclosure, a control of the vehicle based on two-level monitoring is thus proposed. Within the framework of a first monitoring, based on data from the module for position determination of the vehicle, a check is made as to whether the vehicle is within a safely predefined working area within which an autonomous operation of the vehicle is envisaged and allowed. Within the scope of a second check, a sub-area or path within the working area is determined based on data of the sensor system, within which sub-area the vehicle can operate, i.e., can follow both autonomously process and its actual task, e.g., plowing, harvesting or sewing.

By including environment detection, the monitoring of the vehicle is particularly safe and robust. If the global localization fails or should provide inaccurate results, a potential collision object can be determined by checking the environment detection, which can be located within or outside the working area, and suitable countermeasures can be taken in order to avoid a collision. Even if the vehicle should thus leave its work area traveling autonomously as safely predefined, a collision of potential collision objects with the vehicle outside the work area can be avoided. If the vehicle travels autonomously within the work area, the environment detection can contribute to controlling the vehicle particularly safely while avoiding damage to the environment, vehicle, and animals or humans.

The global localization can provide the result that the vehicle is within the working area defined as safe, and that a collision with an object is therefore unlikely. If, however, potential collision objects are still within the working area, a collision with these objects by global localization alone cannot be excluded. The embodiment described below starts here and makes it possible to recognize potential collision objects within the working area defined as safe and to initiate suitable countermeasures for collision avoidance. In this sense, one embodiment of the processor unit is configured to convert the vehicle into a safe state and/or to reduce the speed of the vehicle and/or to give an optical or acoustic warning if the following two conditions are fulfilled simultaneously, namely, firstly, when the position determined by the module for position determination is within the working area predefined to be safe, and secondly, when the environmental detection images at least one potential collision object.

This case can occur, for example, when the vehicle operates normally and/or travels autonomously within the foreseen operating area, and when objects are recognized by the sensor unit within the operating range that is predefined as safe, with which a collision is to be avoided, for example with an object or with a plant such as a tree row, but also with, for example, a Person or with an animal that is located within the work area. This embodiment makes a contribution to increasing the safety within the working area if the vehicle travels autonomously therein, for example by reducing its speed or by alerting persons or animals that are within the working area in front of the vehicle.

The visual or acoustic warning can, for example, be emitted to the local environment of the vehicle, for example by a horn, a signal horn, a speaker, or by a lighting device of the vehicle. The visual or audible warning can be perceived by persons and animals near the vehicle. In this way, persons nearby in front of the autonomously driving vehicle can be warned and collisions can be avoided.

In the best case, the described check steps can provide the result that the vehicle is within the working area predefined as safe, and that there are still no potential collision objects in the local environment of the vehicle. In this case, the vehicle should be able to operate and move autonomously as far as possible without limitations. In this sense, a further embodiment provides that the processor unit is configured to allow the vehicle to be operated autonomously without restrictions, if, firstly, the position determined by the position determination module is within the working area predefined as safe, and if, secondly, the environment detection does not image a potential collision object. In this context, “without limitations” can be understood to mean that the vehicle can be moved autonomously within the first working area without speed limitation within the second working area.

According to a further embodiment, it is planned that the processor unit is configured to define an outer edge strip within the working area defined as safe. If the vehicle is located within this edge strip, which can be determined, for example, by means of GPS localization within the framework of the first test step, the processor unit is also configured to initiate an optical or acoustic warning (as described above). In this way, people and animals that are outside the working area defined as safe can be forewarned of the vehicle, which is indeed still within the working range, but which can be left close to the time under certain circumstances since it is already located within the outer edge strip of the working area defined as safe. This embodiment makes a contribution to avoiding a collision of the vehicle with people and animals that are in the vicinity but still outside of the working range.

In one embodiment, the module for determining the position is configured to perform the position determination of the vehicle by means of a global navigation satellite system. A global navigation satellite system Global Navigation Satellite System; (short: GNSS) is a System for determining the position and Navigation on earth and in the air by receiving the signals, in particular from navigation satellites. Examples of global navigation satellite systems are NAVSTAR GPS or Galileo.

Furthermore, the position determination module can be configured to perform the position determination of the vehicle by means of a method for simultaneous localization and mapping. Algorithms for simultaneous localization and mapping are known. In technical language, the English language “Simultaneous Localization And Mapping” (or abbreviated as: “SLAM”) is typically used. SLAM algorithms usually focus on data that are detected by a sensor. The algorithms can be applied to scans of a sensor frame in order to extract individual points. The individual points can be recognized again in subsequent Scans. Translation and Rotation of these individual points between successive sensor frames can be used to calculate an ego movement of a vehicle and to create a feature map. Furthermore, a recognition of known feature combinations can be used to carry out localization of the vehicle within a previously created map.

For example, features can be extracted from the local environment of the vehicle by means of the sensor unit for detecting the surroundings of the vehicle and used for localization and mapping within the scope of a SLAM procedure. For example, significant tags in the local environment of the vehicle can be used (i.e., extracted in particular from sensor frames), e.g., masts and towers. Alternatively or additionally, tags specifically installed for carrying out the SLAM method can be used at the field edge. Imaging methods can furthermore be used to determine, for example, a boundary of a field, for example in delimitation to other adjacent fields or paths.

The sensor unit for detecting the surroundings of the vehicle may comprise at least one of the following sensors, namely an image processing sensor, e.g., a camera, a radar sensor, a laser-based sensor and an odometer.

By means of known methods of image processing and image evaluation, the image processing sensor (e.g., a camera) can be configured to capture images of the surrounding area and to recognize features in the images.

The radar-based Sensor may be configured to recognize features in the detected environment of the vehicle. The radar-based Sensor may, for example, measure distances to objects within the detected surroundings. Furthermore, the radar-based Sensor can, for example, also measure azimuth values, height values (Elevation), intensity values, and radial velocity values. A corresponding measurement cycle in which the radar-based sensor has detected the environment of the vehicle or measured it in the manner described can be referred to as a “Frame”. The radar-based Sensor can thus scan or detect the environment N-dimensionally, whereby point clouds can be generated. The radar-based Sensor can extract features from detected point clouds. The point cloud may accordingly comprise several dimensions (N-dimensional point cloud), if intensities and radial velocities are also taken into account, for example.

The laser-based sensor (e.g., a lidar sensor) may be configured to detect features in the detected environment of the vehicle. The laser-based Sensor can, for example, measure intensities in an x direction, in a y direction, and in a z direction of a Cartesian coordinate system of the laser-based sensor within the detected surroundings. A corresponding measurement cycle in which the laser-based sensor has detected the environment or measured it in the manner described can be referred to as a “Frame”. The laser-based sensor can scan or detect the environment N-dimensionally, whereby point clouds can be generated. The laser-based sensor can extract features from detected point clouds. The point cloud may accordingly comprise multiple dimensions (N-dimensional point cloud).

The odometer enables a relative position determination of the vehicle. The odometer can be configured to count revolutions of wheels of the vehicle between two measuring times and to determine, via a known Radius of the wheels of the vehicle, a distance that the vehicle traveled between the measuring times. In particular, the odometer can be configured to determine a direction of movement of the vehicle via different rotational speeds of the wheels of the vehicle and/or via a steering wheel of the vehicle. Furthermore, values or vehicle data generated by an inertial measurement Unit (IMU) can also be used, for example, to determine the speed and the yaw movement and the pose and the movement of the vehicle. In motor vehicles, an odometer in the form of a mileage counter can be used, which can typically access measured values from the chassis, in particular measured wheel revolutions and steering data, such as wheel steer angles or steering wheel angles.

The sensor unit can be configured to detect at least one of the following features in the surroundings of the vehicle, namely a track, a plant row, a tree row and a path to work. The track may be located in a field and may have been caused, for example, by previous sewing. Rows of plants are rows of the product in question, for example maize or grapevines. Series of trees can be encountered, for example, on fruit tree plantations, for example, apple plantations. Working paths are found, for example, in mining.

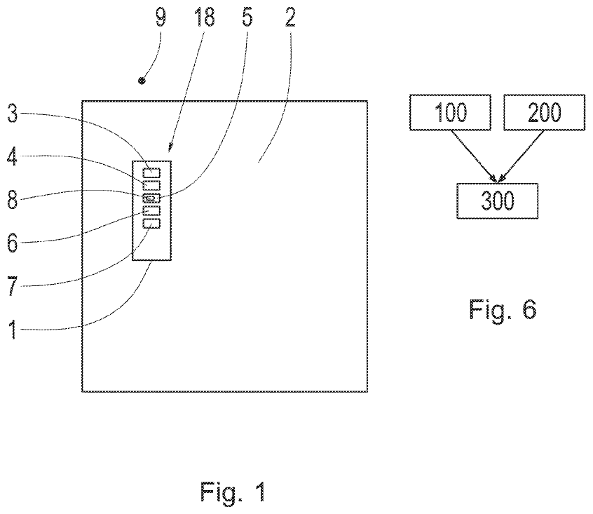

FIG. 1 shows an agricultural machine. The machine can be, for example, an agricultural utility machine, for example a combine harvester. The machine can be operated autonomously. This means that the machine can in particular follow its main function, e.g. Harvest grain, without an occupant controlling it or without an operator remotely controlling the machine, and continue to drive autonomously. In the following, such a machine is referred to by the term “vehicle” and is given the reference sign “1” in the drawing.

The vehicle 1 comprises a System 18 for autonomously operating the vehicle 1 within a safe working area. In the exemplary embodiment shown, the System 18 comprises a GPS module 3 as a module for determining the Position of the vehicle 1. Furthermore, the System 18 may comprise a processor unit 4, a memory unit 5, a communication interface 6 and a sensor unit 7. A computer program product 8 can be stored on the memory unit 5. The computer program product 8, when executed on the processor unit 4, directs the processor unit 4 to carry out the functions or method steps described below.

The vehicle 1 should be operated autonomously in a safe predefined working area 2 (Autonomous Operating Zone, short: AOZ). Outside the working area 2 (e.g. around the working area 2) is a non-autonomous area 9 within which, for example, persons, animals and other vehicles can be located that do not expect the vehicle 1 to move autonomously into the area 9. It is to be avoided that the vehicle 1 moves autonomously out of the work area 2 that is safely predefined and enters the non-autonomous area 9 autonomously. The work area 2 is stored in a map (e.g., in a navigation system of the vehicle 1) that can be accessed by the processor unit 4.

In a first step 100, global localization of the vehicle 1 is carried out. In step 100, global localization can take place by means of various methods, e.g., by means of GNSS. This can be done by means of the GPS module 3. The GPS module 3 can continuously determine a position of the vehicle 1 by means of GNSS. The processor unit 4 can access these positions via the communication interface 6. The positions can be compared by means of the processor unit 4 with the work area 2 stored in the map (see step 300 below). Alternatively, a SLAM method can also be used to determine the Position of the vehicle 1, wherein in this case an adjustment can be made with an internal map (with global coordinates). In order to carry out the SLAM method, significant tags in the environment of the vehicle 1 can be detected and extracted by means of the sensor unit 5, for example masts and towers. Alternatively, tags specifically installed for this (e.g. at a field edge) can also be used for this purpose. Imaging methods can furthermore be used to determine, for example, the boundary of a field, for example to other adjacent fields or paths.

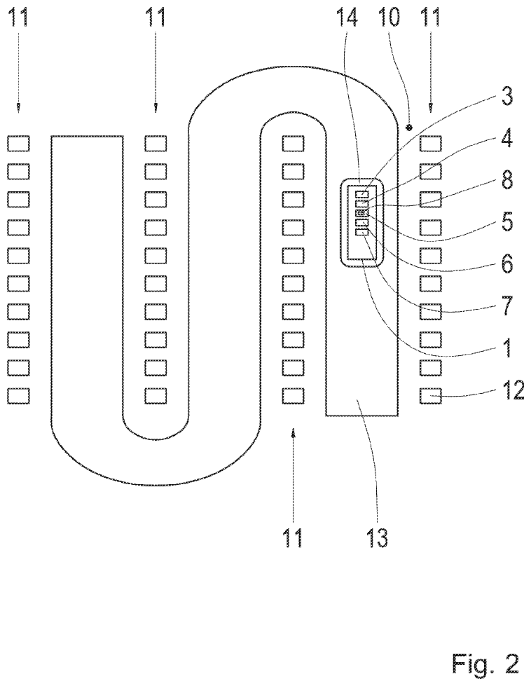

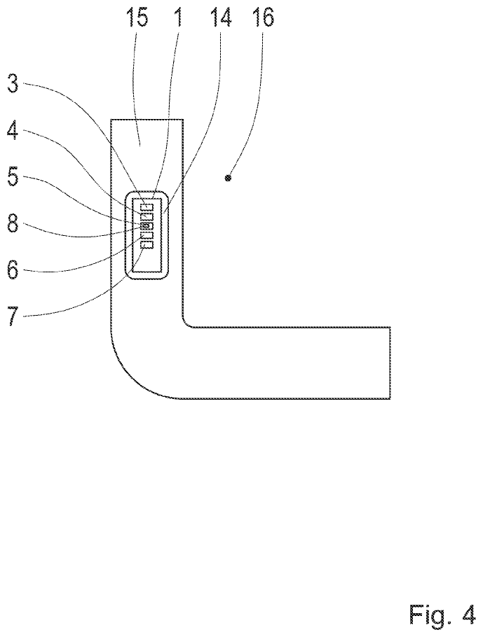

In a second step 200, a local localization is carried out by means of the sensor unit 7 (FIGS. 2 and 4). Steps 100 and 200 may be executed in parallel (as shown by FIGS. 6) or sequentially. During step 200, the sensor unit 7 detects features within a local surroundings 10 of the vehicle 1. For this purpose, the sensor unit 7 can, for example, comprise a camera, a lidar sensor, a radar sensor, or an odometry device. For example, the sensor unit 7 may comprise a Surround View System with several cameras which can detect a field of view in the two-digit meter range. The communication interface 6 can access the features detected by the sensor unit 7 in the local environment 10 of the vehicle 1. The local localization is based on local features in the local environment 10 of the vehicle 1.

In this respect, FIG. 2 shows a first example with four rows of tree 11, each comprising several trees 12 (in FIG. 2, only one tree is provided by way of example with a reference symbol “12”). The sensor unit 7 has detected the environment 10 of the vehicle 1. The trees 12 of the rows of tree 11 can be extracted from a corresponding environmental detection (e.g., from an image of the camera of the sensor unit 7). The extraction may take place, for example, by the processor unit 4 of the vehicle 1. Alternatively, the sensor unit 7 may comprise a further processor unit which can execute the extracting.

The sensor unit 7 can also detect a track 13. There are no potential collision objects in the track. In the track 13, the vehicle 1 can thus travel autonomously collision-free. A collision with the trees 12 of the rows of trees 11 should be avoided in order to prevent damage to the vehicle 1 and the trees 12. In step 200, the processor unit 4 can check whether there are potential collision objects (e.g., the trees 12) within the detected surroundings 10. If the processor unit 4 determines that the trees 12 are located within the detected surroundings 10 of the vehicle 1, for example, it can cause the vehicle 1 to, for example, drive more slowly or even come to a standstill in a step 300. Furthermore, the processor unit 4 can determine how far a potential collision object (e.g. a tree 12) is from the vehicle 1 by suitable evaluations of environment detection and initiate suitable measures for the determined distance. For example, the control unit 7 may cause the vehicle 1 to decelerate strongly when a tree 12 has been detected particularly close to the vehicle 1. On the other hand, the processor unit 4 may cause the vehicle 1 to be only slightly braked, if it has been detected that the tree 12 is located relatively far away from the vehicle 1 within the detected surroundings 10 of the vehicle 1.

Furthermore, in step 200, a region 14 which is located within the local surroundings 10 and within the detected track 13 can be defined by the processor unit 4 as a secure local working area. Within the safe local working area 14, the vehicle 1 is allowed to travel, preferably without reducing the speed of the vehicle 1. On the other hand, the region of the local surroundings 10 within which the recognized trees 12 are located are not defined as a safe working area. The local working area 14 can be located, for example, in the embodiment shown by FIG. 4 extend a few meters around the vehicle 1. The local working area 14 is not static but moves with a movement of the vehicle 1.

FIG. 4 shows a further example with a working path 15 as it is typically to be encountered in mining (opencast mining). The working path 15 is detected by the sensor unit 7. The working path 15 can, for example, be predefined as a safe working area. The sensor unit 7 can also detect objects away from the working path 15, for example cliff walls 16, which can extend perpendicularly and laterally along the working path 15, for example. A collision with the rock walls 16 should be avoided in order to avoid damage to the vehicle 1 and rock walls 16. In order to make this possible, an area 14, which is located within the detected working path 15, can be defined by the processor unit 4 as a safe working area in step 200. The vehicle 1 is allowed to travel within the work area 14. On the other hand, the area within which the recognized rock walls 16 are located is not defined as a safe working area. The safe working area 14 can be found, for example, in the embodiment shown in FIG. 4 may extend around the vehicle 1. The safe working area 14 is not static but moves along with a movement of the vehicle 1.

In a third step 300, local and global AOZ monitoring is performed based on global localization (step 100) and based on local localization (step 200). The global localization of the vehicle 1 (actual position of the vehicle 1) can thus be compared with a predefined map having permitted positions (target range). This target range represents the working range 2 predefined as safe (“global working area”). If the vehicle 1 is located at an edge strip or edge region 17 of the global working area 2 and attempts to unintentionally leave the global working area 2, the vehicle 1 can be transformed into a defined safe state.

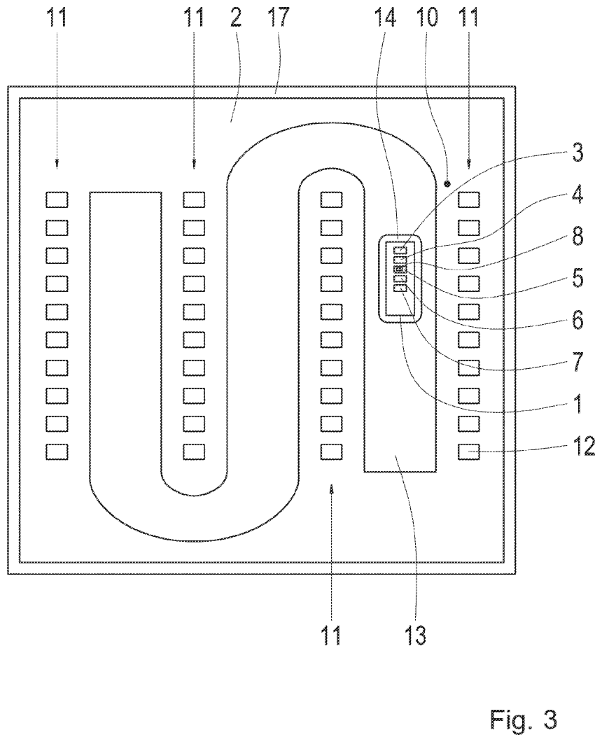

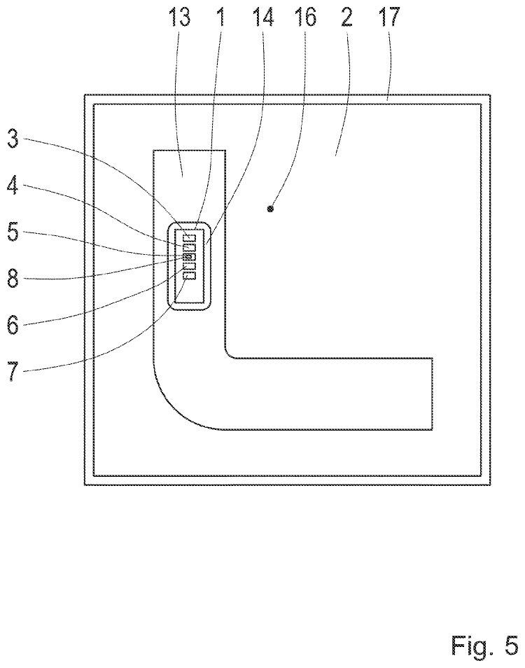

In the third step 300, the results of steps 100 and 200 are superimposed, which enables combined monitoring. FIG. 3 shows the superimposition of the global localization according to FIG. 1 with the local localization according to FIG. 2. Accordingly, FIG. 5 shows the superimposition of the global localization according to FIG. 1 with the local localization according to FIG. 4.

The combination now results in, for example, three areas or options how the vehicle 1 can be driven autonomously or controlled autonomously:

1. The superimposition of local AOZ and global AOZ reveals that the vehicle 1 is located within the global working area 2, and that no potential collision object 12, 14 is located within the local working area 14. This case is illustrated by FIGS. 3 and 5. In this case, autonomous driving can always be permitted. The processor unit 4 does not have to initiate any countermeasures (e.g., reducing the speed or stopping of the vehicle 1) in order to prevent a collision.

2. The superimposition of local VZ and global AOZ reveals that the vehicle 1 is located within the global working area 2. However, it has been determined that a potential collision object 12, 14 is located within the local surroundings 10 of the vehicle 1. This potential collision object 12, 14 can be located, for example, within the local working area 14 or also further away from the vehicle 1, as shown, for example, by FIG. 2 (according to FIG. 2, the trees 12 are located within the local surroundings 10 of the vehicle 1). In this case, the processor unit 4 may cause the vehicle 1 to enter a safe state. Alternatively, the processor unit 4 may also cause a speed reduction of the vehicle 1 to be activated or a visual or acoustic warning to be activated.

3. The superposition of local AOZ and global AOZ reveals that the vehicle 1 is not located within the global working area 2, and that a potential collision object 12, 14 within the local surroundings 10 of the vehicle 1 was also detected. This potential collision object 12, 14 can be located, for example, within the local working area 14 or also further away from the vehicle 1, as shown, for example, by FIG. 2 according to which the trees 12 are located within the local surroundings 10 of the vehicle 1. In this case, the processor unit 4 may cause the vehicle 1 to go directly into a safe state, i.e., cause the vehicle 1 to preferably be stopped immediately.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMBERS

1 Vehicle

2 Global working area of the vehicle

3 GPS module

4 Processor unit

5 Storage unit

6 Communication interface

7 Sensor unit

8 Computer program product

9 Non-autonomous area

10 Local environment of the vehicle

11 Row of trees

12 Tree

13 Track

14 Local working area of the vehicle

15 Working path

16 Rock face

17 Edge region of the global working area

18 System for autonomous operation of the vehicle

100 Procedure step

200 Procedure step

300 Method step

1. An apparatus for autonomously operating a vehicle within a safe work area, the apparatus comprising:
a processor unit comprising an interface, wherein the processor unit is configured to:
access a position of a vehicle determined by a module for position determination through a global localization via the interface,
access an environmental detection of the vehicle generated by a sensor unit via of the interface,
control the vehicle based on the position of the vehicle determined by the module and further based on the environmental detection of the vehicle generated by the sensor unit.

2. The apparatus according to claim 1, wherein the processor unit is further configured to:
check, in a first step, whether the position determined by the module for position determination is within a working area, the working area being predefined as a safe autonomous working area of the vehicle,
check, in a second step, whether the environment detection maps at least one potential collision object, and
control the vehicle based on the results of the two steps.

3. The unit according to claim 2, wherein the processor unit is configured to initiate at least one of the following measures:
to convert the vehicle into a safe state,
reduce the speed of the vehicle, and
give a visual or acoustic warning in response to the position of the vehicle determined by the module for position determination being located within the working area, and the environmental detection maps at least one potential collision object.

4. The apparatus according to claim 2, wherein the processor unit is further configured to allow the vehicle to be operated autonomously without limitations if the position determined by the module for position determination is within the working area and if the environment detection does not map any potential collision object.

5. The apparatus according to claim 2, wherein the processor unit is further configured to define an outer edge strip of the working area, and to initiate a visual or acoustic warning when the vehicle is located within the edge strip.

6. A system for autonomously operating a vehicle within a safe work area, the system comprising
the module for determining the position of a vehicle,
the sensor unit for detecting an environment of the vehicle, and
a processor unit according to claim 1,
wherein the module for position determination is configured to determine the position of a vehicle via a global localization, and
the sensor unit is configured to generate an environment detection of the vehicle

7. The system according to claim 6, wherein the processor unit is further configured to:
in a first step, check whether the position determined by the module for position determination is located within a working area, the working area being predefined as a safe working area of the vehicle,
check, in a second step, whether the environmental detection of the vehicle generated by the sensor unit images at least one potential collision object, and
control the vehicle based on the results of the two steps.

8. The system according to claim 6, wherein the module for determining the position of the vehicle is configured to determine the position of the vehicle via a global navigation satellite system.

9. The system according to claim 6, wherein the module for determining the position of the vehicle is configured to determine the position of the vehicle via a method for simultaneous localization and mapping.

10. The system according to claim 6, wherein the sensor unit comprises at least one of the following sensors:
an image processing sensor,
a radar sensor,
a laser-based sensor, and
an odometer.

11. The system according to claim 6, wherein the sensor unit is configured to detect at least one of the following features in an environment of the vehicle:
a track,
a row of plants,
a row of trees and
a working path.

12. A method for the autonomous operation of a vehicle within a safe working range, the method comprising:
determining a position of a vehicle via global localization by a module for position determination,
generating an environmental detection of the vehicle via a sensor unit,
controlling the vehicle via a processor unit based on the position of the vehicle determined by the global localization and based on the environmental detection of the vehicle generated by the sensor unit.

13. A computer program product comprising processor executable instructions that, when executed on a processor unit, directs the processor unit to:
access the position of a vehicle determined by a module for position determination through a global localization by means of an interface,
access at least one environmental detection of the vehicle generated by a sensor unit by means of the interface, and
control the vehicle based on the position of the vehicle determined by the module and the environmental detection of the vehicle.

14. A computer program product according to claim 13, wherein the processor executable instructions, when executed on the processor unit, directs the processor unit to:
check, in a first step, whether the position determined by the module is within a working area, wherein the working area is predefined as a safe working area of the vehicle,
check, in a second check step, whether the environmental detection maps at least one potential collision object,
control the vehicle based on the results of the two steps.

15. A vehicle, the vehicle comprising an apparatus according to claim 1.
